(19) United States
(12) Patent Application Publication
(10) Pub. No.: US 2013/0075549 A1
(43) Pub. Date: Mar. 28, 2013

(54) Supporting Structure of a stage

(71) Applicants: Wen-Hsiu Huang, Chiayi City (TW); Chu-Ho Chen, Chiayi City (TW)

(72) Inventors: Wen-Hsiu Huang, Chiayi City (TW); Chu-Ho Chen, Chiayi City (TW)

(21) Appl. No.: 13/244,311

(22) Filed: Sep. 24, 2011

(51) Int. Cl. F16M 11/24

(52) U.S. Cl. 248/188.4

(57) ABSTRACT

A support structure of a stage contains a plurality of supports each including: a fixing post having a screwing portion in which an inner thread section is formed; an elevating stem having a stepped hole disposed on a hollow space thereof to correspond to the inner thread section of the fixing post, a stepped abutting rim fixed on an inner side of the stepped hole, and two tabs secured on a first predetermined position to be retracted in or expanded toward a second predetermined position of a stage seat; and a guiding rod having an outer thread section arranged on an outer side thereof to screw with the inner thread section of the fixing post and a non-circular rotating segment disposed on end thereof to be limited on the stepped abutting rim of the stepped hole of the elevating stem.

### BACKGROUND OF THE INVENTION

1. Field of the Invention

The present invention relates to a supporting structure, and more particularly to a supporting structure of a stage that can enhance a horizontal height of the stage and retract a plurality of supports.

2. Description of the Prior Art

A conventional stage has to be assembled to provide performances, such as singing, Chinese comic dialogue, circus, modern drama, debate, etc. Because a plurality of supports have to be provided in a predetermined space and then view a horizontal height of the stage after assembly the stage. Therefore, after the horizontal height of the supports is adjusted, an assembly of the stage is finished. However, a horizontal adjusting position of the support is fixed on a bottom of the support so that a user can enter a bottom surface of the stage to adjust the stage's height and then raise his head to check the horizontal height of the stage, thus adjusting the stage in a long time.

The present invention has arisen to mitigate and/or obviate the afore-described disadvantages.

### SUMMARY OF THE INVENTION

The primary object of the present invention is to provide a supporting structure of a stage that is capable of overcoming the shortcomings of the conventional supporting structure of a stage.

Another object of the present invention is to provide a supporting structure of a stage that can enhance a horizontal height of the stage and retract a plurality of supports.

To obtain the above objectives, a supporting structure of a stage provided by the present invention contains:

a plurality of supports, and each support including:

a fixing post having a screwing portion in which an inner thread section is formed;

an elevating stem having a stepped hole disposed on a hollow space thereof to correspond to the thread section of the fixing post, a stepped abutting rim fixed on an inner side of the stepped hole, and two tabs secured on a first predetermined position to be retracted in or expanded toward a second predetermined position of a stage seat;

a guiding rod having an outer thread section arranged on an outer side thereof to screw with the inner thread section of the fixing post and a non-circular rotating segment disposed on end thereof to be limited on the stepped abutting rim of the stepped hole of the elevating stem, such that the rotating segment of the guiding rod is rotated to adjust a height of the elevating stem.

### BRIEF DESCRIPTION OF THE DRAWINGS

FIG. 1 is a perspective view showing the assembly of a support according to the preferred embodiment of the present invention;

FIG. 2 is a perspective view showing the exploded components of the support according to the preferred embodiment of the present invention;

FIG. 3 is a cross sectional view showing the operation of the support member according to the preferred embodiment of the present invention;

FIG. 4 is another cross sectional view showing the operation of the support member according to the preferred embodiment of the present invention;

FIG. 5 is also another cross sectional view showing the operation of the support member according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

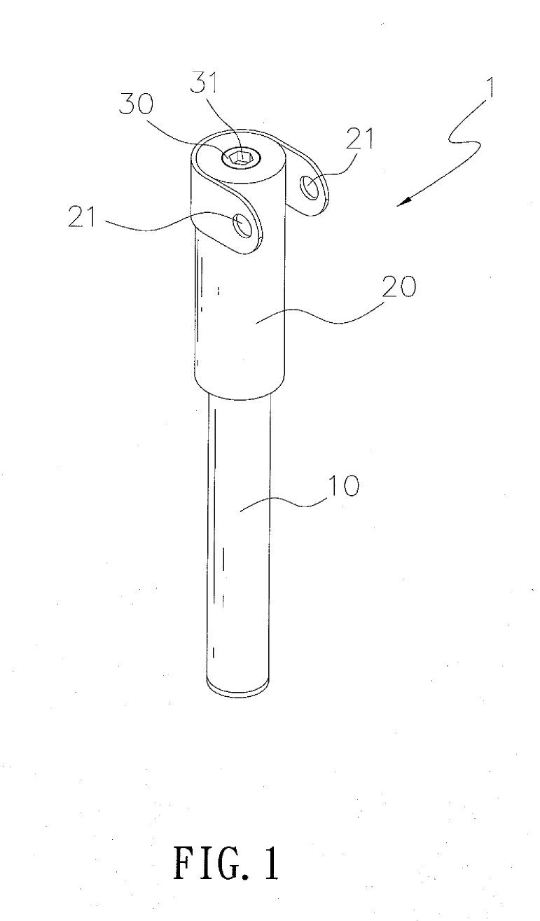

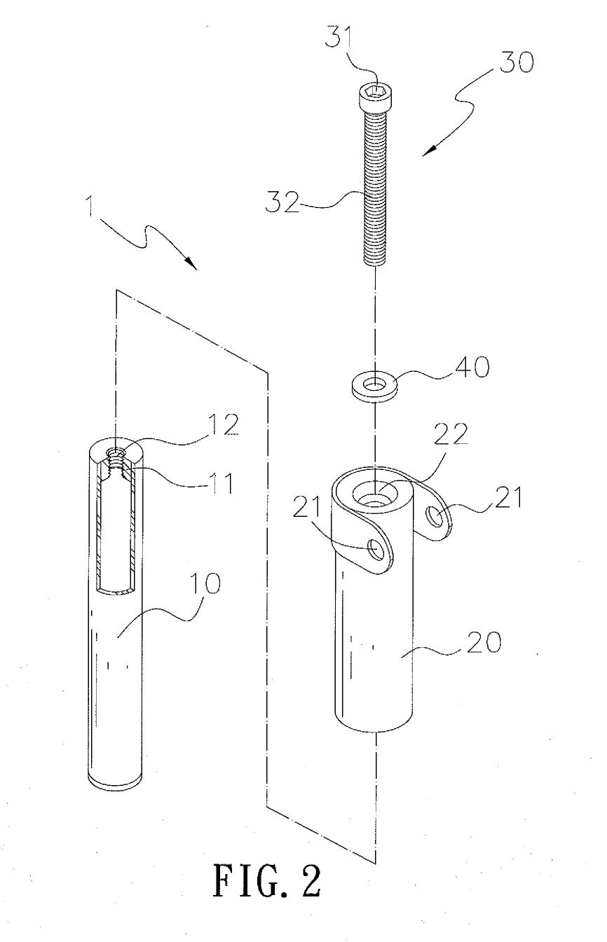

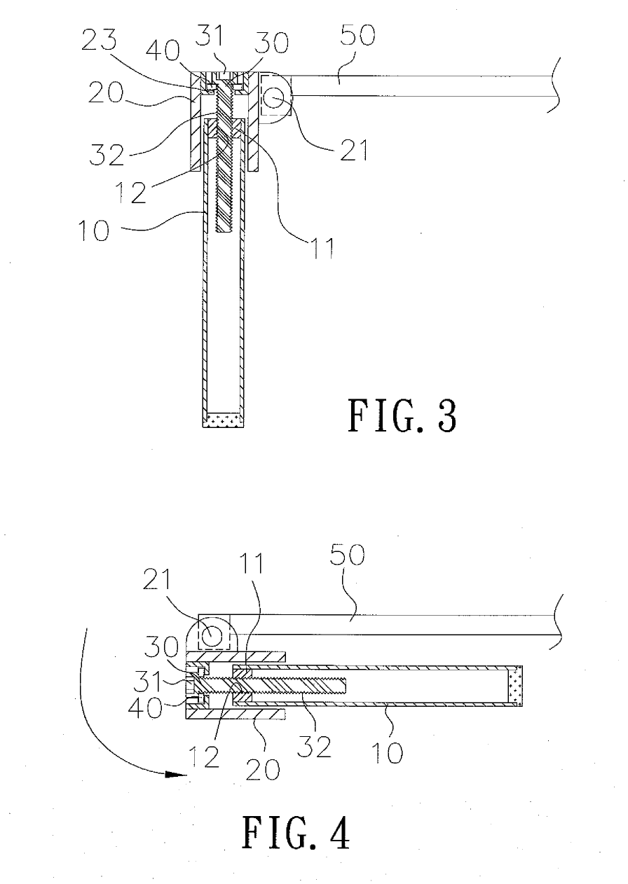

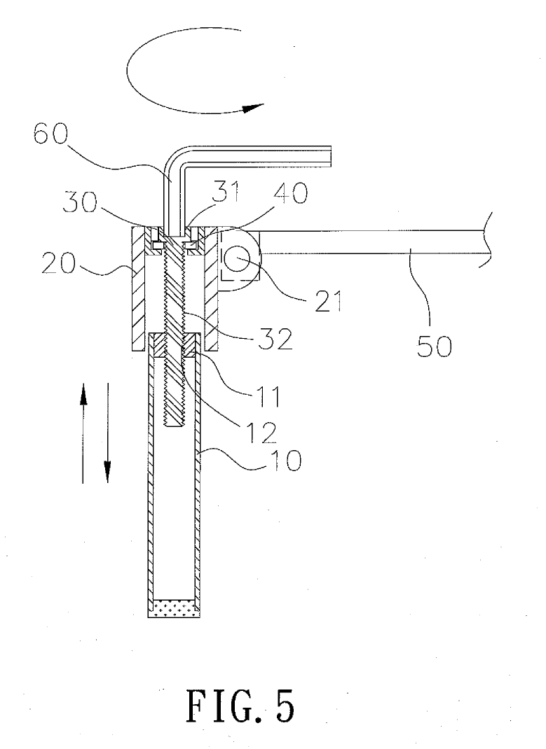

With reference to FIGS. 1-5, a support structure of a stage according to a preferred embodiment of the present invention comprises a plurality of supports 1, and each support 1 includes:

a fixing post 10 having a screwing portion 11 in which an inner thread section 12 is formed;

an elevating stem 20 having a stepped hole 22 disposed on a hollow space thereof to correspond to the thread section 12 of the fixing post 10, a stepped abutting rim 23 fixed on an inner side of the stepped hole 22, and two tabs 21 secured on a first predetermined position to be retracted in or expanded toward a second predetermined position of a stage seat 50;

a guiding rod 30 having an outer thread section 32 arranged on an outer side thereof to screw with the inner thread section 12 of the fixing post 10 and a non-circular rotating segment 31 disposed on end thereof to be limited on the stepped abutting rim 23 of the stepped hole 22 of the elevating stem 20, and between the rotating segment 31 and the stepped abutting rim 23 being defined a pad 40, wherein the rotating segment 31 of the guiding rod 30 is inserted by a non-circular wrench 60 to rotate the rotating segment 31 of the guiding rod 30 so as to adjust a height of the elevating stem 20.

A top end of the support 1 is adjusted to move upward without being adjusted in the stage so that a horizontal height of the stage seat 50 is adjusted quickly and effort-savingly, hence a level of the stage is viewed by a user quickly after the stage is adjusted. In addition, the plurality of supports 1 are retracted in the stage seat 50 or are expanded. Thereby, the stage is capable of being adjusted and the plurality of supports 1 are retracted conveniently.

While we have shown and described various embodiments in accordance with the present invention, it is clear to those skilled in the art that further embodiments may be made without departing from the scope of the present invention.

1. A support structure of a stage comprising;
a fixing post having a screwing portion in which an inner thread section is formed;
an elevating stem having a stepped hole disposed on a hollow space thereof to correspond to the thread section of the fixing post, and a stepped abutting rim fixed on an inner side of the stepped hole;
two spaced, parallel tabs secured on the elevating stem;
a stage seat, with the elevating stem pivotally mounted by the two spaced, parallel tabs to the stage seat between a first predetermined position parallel to the stage seat and a second predetermined position perpendicular to the stage seat; and
a guiding rod having an outer thread section arranged on an outer side thereof to screw with the inner thread section of the fixing post and a non-circular rotating segment disposed on end thereof to be limited on the stepped abutting rim of the stepped hole of the elevating stem, wherein the rotating segment of the guiding rod is rotated to adjust a height of the elevating stem.

2. The support structure of a stage as claimed in claim 1, wherein the rotating segment of the guiding rod includes a non-circular indentation to be inserted by a non-circular wrench to rotate the rotating segment of the guiding rod to adjust the height of the elevating stem.

3. The support structure of a stage as claimed in claim 1, wherein the elevating stem includes a top, with the stopped hole extending from the top, with the top being parallel and coextensive with the stage seat in the second predetermined position and being perpendicular to the stage seat in the first predetermined position.
